(19) United States
(12) Patent Application Publication
(10) Pub. No.: US 2005/0273694 A1
(43) Pub. Date: Dec. 8, 2005

(54) Video television broadcasting

(75) Inventors: Jerome Chouraqui, Paris (FR); Laurent Chouraqui, Paris (FR); Etienne Grange, Paris (FR)

Correspondence Address: IP GROUP OF DLA PIPER RUDNICK GRAY CARY US LLP, 1650 MARKET ST, SUITE 4900, PHILADELPHIA, PA, 19103, US

(73) Assignee: NPTV, a corporation of France, Paris (FR)

(21) Appl. No.: 11/152,949

(22) Filed: Jun. 15, 2005

Related U.S. Application Data
(63) Continuation of application No. PCT/FR03/50182, filed on Dec. 17, 2003.

(30) Foreign Application Priority Data
Dec. 17, 2002 (FR) 02/16034

(51) Int. Cl. G06F 17/00

(52) U.S. Cl. 715/500.1; 725/118

(57) ABSTRACT

A process of time division marking of a video signal intended to be televised including recording an image base, image elements or reference video sequences; comparing a video stream with the image base; recognizing a graphic element in the video stream; and conditionally generating a marking signal when the graphic element is detected, which marking signal is associated with at least a part of the video sequence containing the graphic element.

### RELATED APPLICATION

This is a continuation of International Application No. PCT/FR2003/050182, with an international filing date of Dec. 17, 2003 (WO 2004/057870, published Jul. 8, 2004), which is based on French Patent Application No. 02/16034, filed Dec. 17, 2002.

### FIELD OF THE INVENTION

This invention relates to video television broadcasting, in particular, in the framework of interactive television.

### BACKGROUND

WO 01/50764 A1 is known in the state of the art and describes a computer process for exploiting/operating a digital interactive television transmission broadcast in the form of a digital signal comprising a data stream corresponding to compressed video images and comprising a data stream corresponding to at least one multimedia application, as well as comprising service signals for managing these data streams. That process comprises a stage for detecting the service signal corresponding to a “top of synchronization” sequence comprising:
a sequence assigned to the designation of a multimedia application present in the digital signal,
a signal sequence assigned to the recording of parameters for executing the designated multimedia application, and
a stage for loading the application of the multimedia application and the initialization of the multimedia application with these execution parameters.

Synchronization signals are customarily generated by an interval timer. The synchronization tops are inserted into the video stream as a function of the theoretical broadcasting time of the video sequence associated with a multimedia functionality or a range of interactivity.

That solution is not satisfactory because in reality the televised programs are offset relative to previous schedules.

U.S. Pat. No. 6,239,793 discloses a process for synchronizing the content of a broadcast program and the instructions of a corresponding program of a broadcast of the Internet type. It consists of generating several index values indicating the time during the broadcasting of the program, associating one of the index values with respective instructions in an output of instructtions started during the broadcasting of the program, transmitting the instructions and the associated index values to one or more clients, and associating one of the index values with respective video frames in a video output of the program to indicate the relative time in the program at which the video frame arrives. The process as well as the system use the index values of the video output to determine the synchronization and the sequence of the execution of the instructtions in the instruction output at the level of the client or clients.

WO 00/07361 A relates to a unidirectional, digital video broadcasting network in which the data of the HTML Internet web pages is formatted in such a manner as to insert itself into a standard structure of MPEG-2 data packets, then multiplexed with other video MPEG-2 digital signals in view. The card is updated and rebroadcast every time that a modification intervenes at the start, middle or end of a broadcast video program and the web pages being transmitted at the same time are synchronized with the multi-channel video digital programs broadcasted.

WO 01/65832 A1 relates to a system and process that permit reception of information connected by hypertext links to a television transmission. The material broadcast is analyzed and one or several regions are identified within a frame. Supplementary information can be associated with a region and transmitted in coded form with the aid of synchronization information that permit identification of the frame with which the information is associated. The system comprises: a video source and a coder that produces a transport stream in communication with the video source; an annotation source; a generator of data packet streams that produces coded annotation data packets in communication with the adaptation source and the coder; and a multiplexer system in communication with the coder and the generator of data packet streams. The coder supplies time-stamping information to the generator of data packet streams and in response to the time-stamping information the generator of data packet streams synchronizes the annotation data coming from the adaptation source with a video signal coming from the video source. The multiplexer produces a digital broadcasting signal comprising a transport stream augmented from the transport stream and packets of coded data. A receiver displays the adaptation information associated with the video signal in response to a user request image by image. The television viewer can respond in an interactive manner to the material, including making commercial transactions with the aid of an auxiliary channel intended for interactive communication.

### SUMMARY OF THE INVENTION

This invention relates to a process of time division marking of a video signal intended to be televised including recording an image base, image elements or reference video sequences, comparing a video stream with the image base, recognizing a graphic element in the video stream, and conditionally generating a marking signal when the graphic element is detected, which marking signal is associated with at least a part of the video sequence containing the graphic element.

This invention also relates to apparatus for generating a synchronization signal of a video stream associated with the process of time division marking of a video signal intended to be televised, including a recorder of the image base, elements of images or reference video sequences, a comparator that makes a comparison between content of the video stream and the reference base, and a device that adds a synchronization signal in case of a positive comparison.

This invention further relates to a process for conditional display of video sequences, including constituting an image base, elements of images or reference video sequences, enhancing the video stream by addition of synchronization signals in accordance with the process of time division marking of a video signal intended to be televised, recognizing a graphic element in the video stream, conditionally generating a marking signal when the graphic element is detected, which marking signal is associated with at least a part of the video sequence containing the graphic element, and generating multimedia data that can be activated by the synchronization signal.

### DETAILED DESCRIPTION

This invention provides an efficacious solution to the problem of synchronizing a televised video transmission with an associated task and, in particular, but in a non-limiting manner, the problem of functions of interactivity.

To this end the invention relates in accordance with a general meaning to a process of the time division marking of a video signal intended to be televised, comprising a stage for recognizing a graphic element in the video stream and conditional generation of a marking signal in the case of the detection of the graphic element, which marking signal is associated with at least a part of the video sequence containing the graphic element.

This solution allows for synchronization to be guaranteed between the video and the enhancement functions with a fluidity that was not possible to be achieved with the prior solutions.

The process advantageously comprises a prior stage of recording at least one image element, one image or a reference video sequence.

The invention also relates to equipment for generating a synchronization signal of a video stream comprising means for recording an image base, elements of images or reference video sequences and means for making a comparison between the content of the video stream and the reference base, as well as means for adding a synchronization signal in the case of positive comparison.

The invention also relates to a particular application of the marking solution for applications such as parental control.

The process for conditional display of video sequences comprises a stage for the constitution of an image base, elements of images or reference video sequences and implements an enhancement stage of the video stream by addition of synchronization signals in accordance with the marking process comprising a stage for the recognition of a graphic element in the video stream and for the conditional generation of a marking signal in the case of the detection of the graphic element, which marking signal is associated with at least a part of the video sequence containing the graphic element, which process furthermore comprises a stage for generating multimedia data that can be activated by the synchronization signal.

The invention will be better understood from a reading of the following description that refers to an exemplary non-limiting example.

The image or images or reference video sequences are recorded in a database.

The video server comprises a computer controlled by a program for comparing images realizing the detection of reference images in the stream to be broadcast.

When the reference information is detected, the computer orders the sending of a synchronization event (top of synchronization) to the synchronization interface, which adds a synchronization signal of the same nature as the timing signals of the prior art.

This timing signal controls a digital application (start, interruption, refreshing of data or activation of an internal screen for a digital application) associated with the video stream.

If necessary, the synchronization signal can control the interactivity of connected equipment, e.g., for controlling the generation of a fixed screen with interactivity toward other channels or a request to input a particular code when the video stream comprises images such as pornographic images.

1. A process of time division marking of a video signal intended to be televised comprising:
recording an image base, image elements or reference video sequences;
comparing a video stream with the image base;
recognizing a graphic element in the video stream; and
conditionally generating a marking signal when the graphic element is detected, which marking signal is associated with at least a part of the video sequence containing the graphic element.

2. Apparatus for generating a synchronization signal of a video stream associated with the process of claim 1, comprising:
a recorder of the image base, elements of images or reference video sequences;
a comparator that makes a comparison between content of the video stream and the reference base; and
a device that adds a synchronization signal in case of a positive comparison.

3. A process for conditional display of video sequences, comprising:
constituting an image base, elements of images or reference video sequences;
enhancing the video stream by addition of synchronization signals in accordance with the process according to claim 1;
recognizing a graphic element in the video stream;
conditionally generating a marking signal when the graphic element is detected, which marking signal is associated with at least a part of the video sequence containing the graphic element; and
generating multimedia data that can be activated by the synchronization signal.

4. Apparatus for generating a synchronization signal of a video stream associated with the process of claim 1, comprising:
means for recording the image base, elements of images or reference video sequences;
means for comparing between content of the video stream and the reference base; and
means for adding a synchronization signal in case of a positive comparison.
